(19) United States
(12) Patent Application Publication
(10) Pub. No.: US 2025/0384325 A1
(43) Pub. Date: Dec. 18, 2025

(54) LEARNING NOISE MODELS TO PERFORM QUANTUM ERROR MITIGATION ON UNSTRUCTURED QUANTUM CIRCUITS

(71) Applicant: International Business Machines Corporation, Armonk, NY (US)

(72) Inventors: Bradley K. Mitchell, San Jose, CA (US); Ewout van den Berg, Bronxville, NY (US); Abhinav Kandala, Yorktown Heights, NY (US)

(21) Appl. No.: 18/742,662

(22) Filed: Jun. 13, 2024

(51) Int. Cl. G06N 10/70; G06N 10/60

(52) U.S. Cl. CPC G06N 10/70; G06N 10/60

(57) ABSTRACT

A method, system, and computer program product for learning noise models to perform quantum error mitigation. Each target layer of a quantum circuit is divided into a set of sub-layers. Each of the sub-layers for each target layer of the quantum circuit is grouped into a reduced set of learning layers, which enables each sub-layer's noise model to be learned from fewer layers (learning layers). A learning layer refers to a layer that is used in combination with other learning layers to form the minimally complete layer set for learning all the layer components used in the quantum circuit. The noise models for each of the sub-layers are then learned on the reduced set of learning layers. Such learned noise models are combined to form a complete set of noise models for the target layers of the quantum circuit and used to perform quantum error mitigation on the quantum circuit.

### TECHNICAL FIELD

The present disclosure relates generally to quantum error mitigation, and more particularly to learning noise models to perform quantum error mitigation on unstructured quantum circuits (quantum circuits containing many unique layers).

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of superposition and entanglement, and quantum computing leverages this behavior using specialized hardware that supports the preparation and manipulation of quantum states. Classical physics cannot explain the operation of these quantum devices, and a scalable quantum computer could perform some calculations exponentially faster than any modern “classical” computer.

Quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty measurement outcomes.

Techniques, such as quantum error mitigation techniques, have been developed to reduce (mitigate) the errors that occur in quantum computing algorithms. Recently, quantum error mitigation techniques have been performed using learned noise models (e.g., sparse Pauli noise models) to perform accurate calculations with noisy quantum hardware. A noise model refers to a computer model used to predict the noise acting on the quantum state of a noisy quantum computer. For example, a sparse Pauli noise model is a model for the noise acting on the quantum state of a noisy quantum computer under the action of a Clifford layer with Pauli twirling. Such noise models, such as the sparse Pauli noise model, are learned according to a noise learning protocol, where each unique layer of gates in the quantum circuit has an associated noise model.

The noise model for each layer of the quantum circuit may then be inverted quasi-probabilistically according to the noise learning protocol or used for zero-noise extrapolation to perform quantum error mitigation thereby allowing the estimation of noise-free observable expectation values.

Unfortunately, quantum error mitigation using learned noise models is limited to quantum circuits with a small set of unique quantum gate layers. Quantum circuits though may contain many unique layers which makes it difficult to learn each unique layer noise model. For example, because the noise properties of noisy quantum computers drift on a timescale of about a day or less, learning the noise models needs to be performed as quickly as possible to ensure that the learned noise model reflects current device conditions. However, because of the long time to learn the noise models, the noise models for each layer of a quantum circuit that contains many unique layers may not be learned quick enough to address the device's noise drift. Drift is any nontrivial time dependence in the outcome probabilities of a quantum circuit. As a result, the drifted noise (drifting of the noise properties of noisy quantum computers) creates a mismatch between the actual noise characteristics on the quantum hardware and the noise model.

Consequently, due to drifting device noise, the current approach of learning each unique layer noise model for a quantum circuit is limited in the number of unique layers than can be learned before the learned noise models are no longer representative of the current device noise environment.

### SUMMARY

In one embodiment of the present disclosure, a method for learning noise models to perform quantum error mitigation comprises dividing each target layer of a quantum circuit into a set of sub-layers. The method further comprises grouping each of the set of sub-layers for each target layer of the quantum circuit into a reduced set of learning layers. The method additionally comprises learning the noise models for each of the set of sub-layers based on the reduced set of learning layers.

Additionally, in one embodiment of the present disclosure, each sub-layer in the set of sub-layers comprises each single and two-qubit gate in a target layer of the quantum circuit.

Furthermore, in one embodiment of the present disclosure, the method additionally comprises grouping each of the set of sub-layers for each target layer of the quantum circuit using a gate crosstalk graph.

Additionally, in one embodiment of the present disclosure, the grouping of each of the set of sub-layers for each target layer of the quantum circuit into the reduced set of learning layers comprises combining all parallelizable components in each of the set of sub-layers for each target layer of the quantum circuit.

Furthermore, in one embodiment of the present disclosure, the method additionally comprises combining the learned noise models forming a complete set of noise models for target layers of the quantum circuit.

Additionally, in one embodiment of the present disclosure, the method further comprises performing quantum error mitigation on the quantum circuit using the learned noise models.

Furthermore, in one embodiment of the present disclosure, the quantum circuit is unstructured.

Other forms of the embodiments of the method described above are in a system and in a computer program product.

Accordingly, embodiments of the present disclosure learn the noise models for the target layers of the quantum circuits before the learned noise models are no longer representative of the current device noise environment due to drifting device noise.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for learning noise models to perform quantum error mitigation on unstructured quantum circuits in accordance with an embodiment of the present disclosure;

FIG. 3 illustrates a 1D (one-dimensional) fully entangled GHZ state (Greenberger-Horne-Zeilinger state) preparation circuit in accordance with an embodiment of the present disclosure;

FIG. 4 illustrates a target layer of the quantum circuit along with the sub-layers of the target layer in accordance with an embodiment of the present disclosure;

FIG. 5 illustrates a gate crosstalk graph in accordance with an embodiment of the present disclosure;

FIG. 6 illustrates a minimally complete layer set for learning all the layer components used in the target quantum circuit in accordance with an embodiment of the present disclosure;

FIG. 7 illustrates learning layers being formed from the grouping of sub-layers for each target layer in accordance with an embodiment of the present disclosure;

FIGS. 8A-8B illustrate using the gate crosstalk subgraph when forming the learning layers for learning the sub-layer noise models in accordance with an embodiment of the present disclosure;

FIG. 9 illustrates an embodiment of the present disclosure of the hardware configuration of the classical computer which is representative of a hardware environment for practicing the present disclosure; and

FIG. 10 is a flowchart of a method for learning noise models to perform quantum error mitigation on quantum circuits in accordance with an embodiment of the present disclosure.

### DETAILED DESCRIPTION

In one embodiment of the present disclosure, a method for learning noise models to perform quantum error mitigation comprises dividing each target layer of a quantum circuit into a set of sub-layers. The method further comprises grouping each of the set of sub-layers for each target layer of the quantum circuit into a reduced set of learning layers. The method additionally comprises learning the noise models for each of the set of sub-layers based on the reduced set of learning layers.

In this manner, the noise models for the target layers of the quantum circuits can be learned before the learned noise models are no longer representative of the current device noise environment due to drifting device noise.

Additionally, in one embodiment of the present disclosure, each sub-layer in the set of sub-layers comprises each single and two-qubit gate in a target layer of the quantum circuit.

In this manner, each sub-layer could correspond to each single and two-qubit gate in the target layer of the quantum circuit in the ideal case of zero crosstalk.

Furthermore, in one embodiment of the present disclosure, the method additionally comprises grouping each of the set of sub-layers for each target layer of the quantum circuit using a gate crosstalk graph.

In this manner, the sub-layers are combined in the same learning layer using a gate crosstalk graph.

Additionally, in one embodiment of the present disclosure, the grouping of each of the set of sub-layers for each target layer of the quantum circuit into the reduced set of learning layers comprises combining all parallelizable components in each of the set of sub-layers for each target layer of the quantum circuit.

In this manner, fewer unique layers are formed to learn the sub-layers' noise models.

Furthermore, in one embodiment of the present disclosure, the method additionally comprises combining the learned noise models forming a complete set of noise models for target layers of the quantum circuit.

In this manner, the noise models of the target layers of the quantum circuit are stitched together from the sub-layer noise model components.

Additionally, in one embodiment of the present disclosure, the method further comprises performing quantum error mitigation on the quantum circuit using the learned noise models.

In this manner, quantum error mitigation may be effectively performed on a quantum circuit using learned noise models.

Furthermore, in one embodiment of the present disclosure, the quantum circuit is unstructured.

In this manner, noise models are learned to perform quantum error mitigation on quantum circuits containing many unique layers.

Other forms of the embodiments of the method described above are in a system and in a computer program product.

As stated above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty measurement outcomes.

Techniques, such as quantum error mitigation techniques, have been developed to reduce (mitigate) the errors that occur in quantum computing algorithms. Recently, quantum error mitigation techniques have been performed using learned noise models (e.g., sparse Pauli noise models) to perform accurate calculations with noisy quantum hardware. A noise model refers to a computer model used to predict the noise acting on the quantum state of a noisy quantum computer. For example, a sparse Pauli noise model is a model for the noise acting on the quantum state of a noisy quantum computer under the action of a Clifford layer with Pauli twirling. Such noise models, such as the sparse Pauli noise model, are learned according to a noise learning protocol, where each unique layer of gates in the quantum circuit has an associated noise model.

The noise model for each layer of the quantum circuit may then be inverted quasi-probabilistically according to the noise learning protocol or used for zero-noise extrapolation to perform quantum error mitigation thereby allowing the estimation of noise-free observable expectation values.

Unfortunately, quantum error mitigation using learned noise models is limited to quantum circuits with a small set of unique quantum gate layers. Quantum circuits though may contain many unique layers which makes it difficult to learn each unique layer noise model. For example, because the noise properties of noisy quantum computers drift on a timescale of about a day or less, learning the noise models needs to be performed as quickly as possible to ensure that the learned noise model reflects current device conditions. However, because of the long time to learn the noise models, the noise models for each layer of a quantum circuit that contains many unique layers may not be learned quick enough to address the device's noise drift. Drift is any nontrivial time dependence in the outcome probabilities of a quantum circuit. As a result, the drifted noise (drifting of the noise properties of noisy quantum computers) creates a mismatch between the actual noise characteristics on the quantum hardware and the noise model.

Consequently, due to drifting device noise, the current approach of learning each unique layer noise model for a quantum circuit is limited in the number of unique layers than can be learned before the learned noise models are no longer representative of the current device noise environment.

The embodiments of the present disclosure provide the means for learning many unique layer noise models for a quantum circuit before the learned noise models are no longer representative of the current device noise environment by leveraging low device crosstalk. Crosstalk, as used herein, refers to when one gate application affects the performance of a separate gate application (e.g., a CNOT gate on one pair of qubits adds an error to a CNOT gate on another pair of qubits). Leveraging low device crosstalk, as used herein, refers to noise model coefficients on different components of the quantum device not affecting each other (i.e., they are relatively independent). For example, many unique layers of a quantum circuit share common gate operations (referred to herein as “sub-layers”) between them and many gate operations have low crosstalk. That is, such gate operations are mostly independent of each other such that the operation of one gate does not significantly affect the operation of the other gate. For instance, two gate layers may have different gates on one set of qubits, but the layers both have a CNOT gate on one pair of qubits. If there is no crosstalk between the gate operation, then the noise model coefficients for the shared CNOT gate will be identical for both layers. Thus, learning the noise model coefficients for this CNOT gate in both layers is unnecessary. In one embodiment, the number of learning experiments needed to determine the target layer noise models is reduced by dividing each target layer of the quantum circuit into sub-layers that can be re-arranged into a smaller set of “learning layers.” The “target layer” of the quantum circuit, as used herein, refers to a layer of the quantum circuit upon which quantum error mitigation is to be performed. As a result, such noise models do not need to be learned from the larger set of unique target layers separately. Instead, the noise models of the independent sub-layers are learned from such learning layers. The noise models of the sub-layers are then combined to form the complete set of noise models for the target layers of the quantum circuit. As a result, a complete set of noise models for the target layers of the quantum circuit can be learned before the learned noise models are no longer representative of the current device noise environment due to drifting device noise. These and other features will be discussed in further detail below.

In some embodiments of the present disclosure, the present disclosure comprises a method, system, and computer program product for learning noise models to perform quantum error mitigation. In one embodiment of the present disclosure, each target layer of a quantum circuit is divided into a set of sub-layers. The “target layer” of the quantum circuit, as used herein, refers to a layer of the quantum circuit upon which quantum error mitigation is to be performed. A “layer,” as used herein, refers to a quantum gate (unitary matrix U_{L}) acting on a set of qubits, usually a combination of single and two-qubit gates acting in parallel. That is, the layer includes the component operations that are applied simultaneously to the quantum device (e.g., quantum circuit). A “sub-layer,” as used herein, refers to a quantum gate(s) or component operation(s) acting on a subset of a larger layer (e.g., target layer). Furthermore, each of the sub-layers for each target layer of the quantum circuit is grouped into a reduced set of “learning layers,” which enables each sub-layer's noise model to be learned from fewer layers (learning layers). A “learning layer,” as used herein, refers to a layer (a quantum gate acting on a set of qubits) that is used in combination with other learning layers to form the minimally complete layer set for learning all the layer components used in the quantum circuit. In one embodiment, such grouping combines all the parallelizable components of the sub-layers into a minimal set of layers (i.e., learning layers) for learning all the layer components used in the quantum circuit. The noise models for each of the sub-layers are then learned on the reduced set of learning layers. In one embodiment, the noise models for the learning layers are learned according to a noise learning protocol in which the learning layers contain layers of noisy two-qubit gates interleaved with layers of single-qubit gates. Such learned noise models are combined to form a complete set of noise models for the target layers of the quantum circuit and used to perform quantum error mitigation on the quantum circuit. In this manner, a complete set of noise models for the target layers of the quantum circuit can be learned before the learned noise models are no longer representative of the current device noise environment due to drifting device noise.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

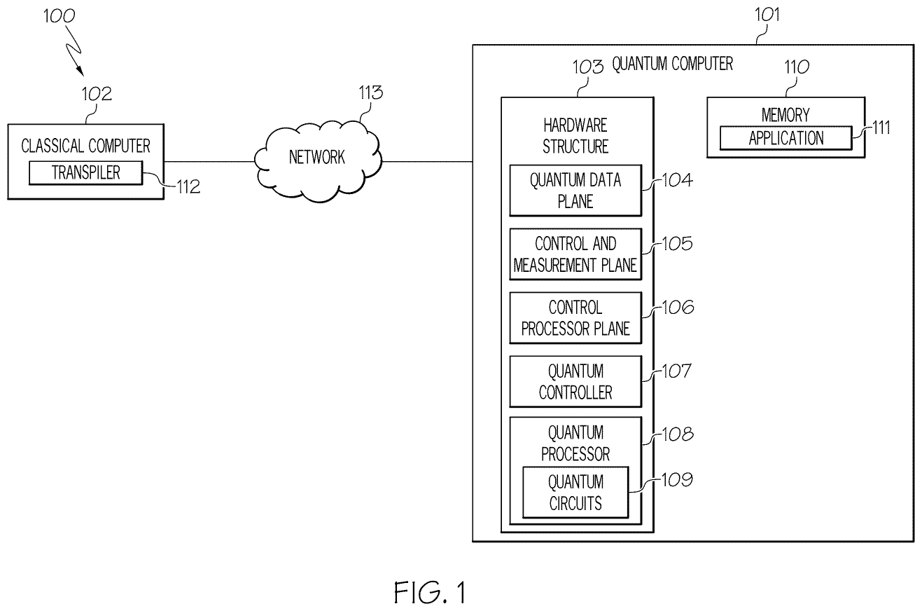

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to learn noise models to perform quantum error mitigation on unstructured quantum circuits as discussed further below.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθXΘX/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

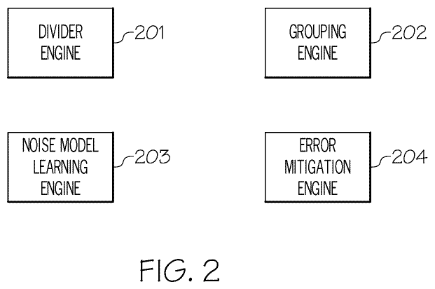

In one embodiment, memory 110 stores an application 111 that may be configured to implement one or more of the methods described herein in accordance with one or more embodiments. For example, application 111 may implement a program for learning noise models to perform quantum error mitigation on unstructured quantum circuits as discussed further below in connection with FIGS. 2-7, 8A-8B and 10. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

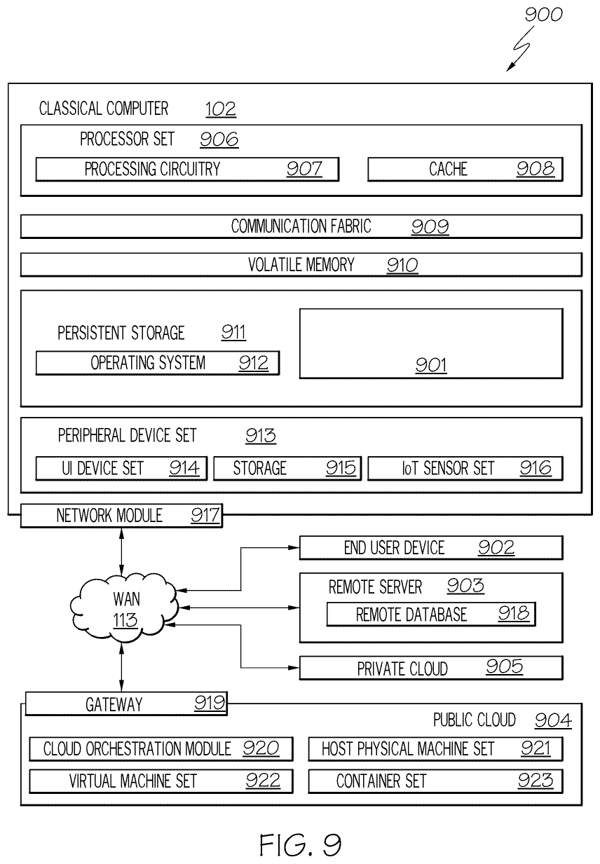

Furthermore, classical computer 102 is configured to learn noise models to perform quantum error mitigation on unstructured quantum circuits as discussed further below in connection with FIGS. 2-7, 8A-8B and 10. A description of the software components of classical computer 102 is provided below in connection with FIG. 2 and a description of the hardware configuration of classical computer 102 is provided further below in connection with FIG. 9.

System 100 is not to be limited in scope to any one particular network architecture. System 100 may include any number of quantum computers 101, classical computers 102, and networks 113.

A discussion regarding the software components used by classical computer 102 for learning noise models to perform quantum error mitigation on unstructured quantum circuits is provided below in connection with FIG. 2.

FIG. 2 is a diagram of the software components of classical computer 102 (FIG. 1) for learning noise models to perform quantum error mitigation on unstructured quantum circuits in accordance with an embodiment of the present disclosure.

Referring to FIG. 2, in conjunction with FIG. 1, classical computer 102 includes divider engine 201 configured to divide each target layer of a quantum circuit (e.g., quantum circuit 109) into a set of sub-layers. The “target layer” of the quantum circuit, as used herein, refers to a layer of the quantum circuit upon which quantum error mitigation is to be performed. A “layer,” as used herein, refers to a quantum gate (unitary matrix U_{L}) acting on a set of qubits, usually a combination of single and two-qubit gates acting in parallel. That is, the layer includes the component operations that are applied simultaneously to the quantum device (e.g., quantum circuit). A “sub-layer,” as used herein, refers to a quantum gate(s) or component operation(s) acting on a subset of a larger layer (e.g., target layer).

In one embodiment, divider engine 201 identifies the quantum gate(s) or component operation(s) acting on a subset of a larger layer (e.g., target layer) by using the QuantumCircuit.data function of Qiskit®. Based on such an identification, such quantum gate(s) or component operation(s) form the sub-layer(s) of the targe layer.

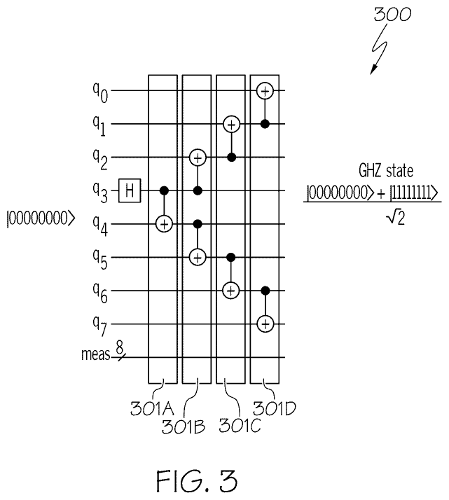

An example of a quantum circuit (e.g., quantum circuit) with multiple target layers is provided in FIG. 3.

FIG. 3 illustrates a 1D (one-dimensional) fully entangled GHZ state (Greenberger-Horne-Zeilinger state) preparation circuit 300 in accordance with an embodiment of the present disclosure.

As shown in FIG. 3, the number of unique layers (target layers)=N/2 for N qubits. For example, circuit 300 includes 8 qubits (qₒ to q₇). As a result, circuit 300 has 4 unique layers (target layers) 301A-301D. Layers 301A-301D may collectively or individually be referred to as layers 301 or layer 301, respectively.

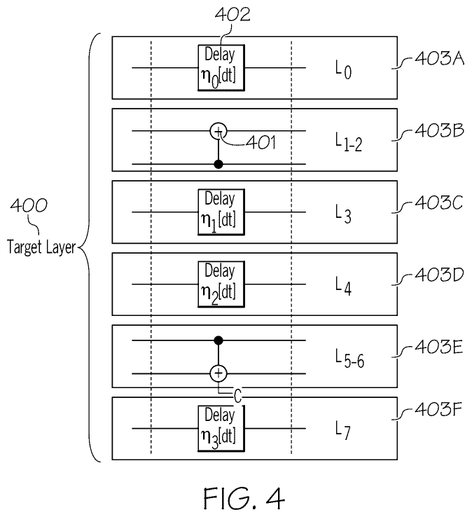

Returning to FIG. 2, as discussed above, a layer refers to a quantum gate (unitary matrix U_{L}) acting on a set of qubits, usually a combination of single and two-qubit gates acting in parallel. In one embodiment, each gate layer has a unique model associated with it. A “sub-layer” refers to a quantum gate acting on a subset of a larger layer as illustrated in FIG. 4. Noise models for the sub-layers can be learned separately.

FIG. 4 illustrates a target layer of the quantum circuit (e.g., ID fully entangled GHZ state preparation circuit 300) along with the sub-layers of the target layer in accordance with an embodiment of the present disclosure.

As shown in FIG. 4, target layer 400 (e.g., layer 301A of circuit 300) consists of various component operations that are applied simultaneously to the device (e.g., quantum circuit), such as two parallel CX gates 401 and idle gates 402. In one embodiment, divider engine 201 divides target layer 400 into a set of sub-layers 403A-403F (identified as L₀, L₁₋₂, L₃, Lᵣ, L₅₋₆, L₇, respectively, in FIG. 4) consisting of the target layer component operations (e.g., CX gates 401, idle gates 402). Sub-layers 403A-403F may collectively or individually be referred to as sub-layers 403 or sub-layer 403, respectively. While FIG. 4 illustrates six sub-layers 403, each target layer 400 may include any number of sub-layers 403. As discussed above, sub-layers 403 include the component operations of the target layer, such as target layer 400.

Since the model coefficients on one edge or qubit do not affect the coefficients on another edge/qubit, there is no/low crosstalk. Hence, L_{c}=⊗Lᵢ, where Lᵢ corresponds to sub-layers 403 defined on the components (qubits, edges) of the target layer L_{c}. It is noted that ⊗ corresponds to the tensor product as Lᵢ is a unitary operation on sub-graph i.

In one embodiment, in the ideal case of zero crosstalk, each sub-layer 403 could simply be each single and two-qubit gate in target layer 400. Crosstalk, as used herein, refers to when one gate application affects the performance of a separate gate application (e.g., a CNOT gate on one pair of qubits adds an error to a CNOT gate on another pair of qubits).

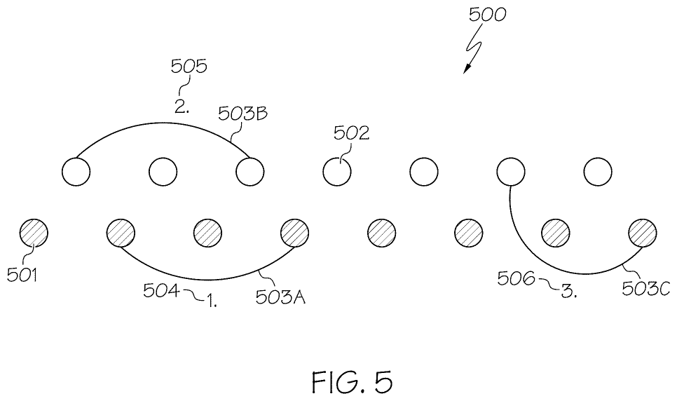

In one embodiment, divider engine 201 divides each target layer 400 of the quantum circuit (e.g., ID fully entangled GHZ state preparation circuit 300) into a set of sub-layers 403 taking into consideration cross-talk. For example, if one gate's noise model is known to depend on whether another gate is also present in target layer 400, then those two gates can be grouped to form a sub-layer 403. In one embodiment, divider engine 201 obtains such cross-talk information using a gate crosstalk graph of the device (e.g., quantum circuit) as illustrated in FIG. 5.

Referring to FIG. 5, FIG. 5 illustrate a gate crosstalk graph 500 in accordance with an embodiment of the present disclosure.

As shown in FIG. 5, gate crosstalk graph 500 illustrates crosstalk between gates by using nodes 501, 502 corresponding to single-qubit gates (S) (e.g., idle gates, do nothing gates) and two-qubit gates (T), respectively. Furthermore, edges 503A-503C indicate crosstalk between gates 501, 502. Edges 503A-503C may collectively or individually be referred to as edges 503 or edge 503, respectively. It is noted that gate crosstalk graph 500 may include any number of nodes 501, 502 and edges 503 and that gate crosstalk graph 500 is not to be limited in scope to the depicted number of nodes 501, 502 and edges 503.

As further shown in FIG. 5, gate crosstalk graph 500 illustrates three types of crosstalk types. For example, gate crosstalk graph 500 illustrates crosstalk between single-qubit gates (S) 501, resulting in the crosstalk type of S-S, which is labeled as “1” 504 in FIG. 5. In another example, gate crosstalk graph 500 illustrates crosstalk between two-qubit gates (T) 502, resulting in the crosstalk type of T-T, which is labeled as “2” 505 in FIG. 5. In a further example, gate crosstalk graph 500 illustrates crosstalk between a single-qubit gate (S) and a two-qubit gate (T) or vice-versa, resulting in the crosstalk type of S-T or T-S, which is labeled as “3” 506 in FIG. 5.

In one embodiment, with information about gate crosstalk graph 500 of the quantum device (e.g., quantum circuit), sub-layers 403 of a target layer 400 will be the set of connected subgraphs of target layer 400 on gate crosstalk graph 500.

For example, in the scenario in which a CNOT gate on one pair of qubits adds an error to a CNOT gate on another pair of qubits, divider engine 201 divides target layer 400 in such a manner that a sub-layer 403 would contain both CNOT gates.

In one embodiment, divider engine 201 obtains gate crosstalk graph 500 by detecting the existence of crosstalk based on detecting changes in the observe outcome frequencies for the quantum circuit (e.g., quantum circuit 109). In one embodiment, quantum circuit 109 is run on “spectator” qubit(s) while leaving alone the “driver” qubit(s). The process is then repeated while gates are run on the driver qubit(s). Based on the consistency of the two datasets, crosstalk can be detected.

In another embodiment, divider engine 201 obtains gate crosstalk graph 500 by quantifying crosstalk through idle tomography involving identifying the idle decay rate differences (equal to the sum of stochastic Y and Z errors induced by crosstalk) on the spectator qubit(s), where the type and rate of crosstalk errors can be inferred.

In one embodiment, divider engine 201 obtains gate crosstalk graph 500 by detecting crosstalk via conditional independence testing.

Classical computer 102 further includes grouping engine 202 configured to group each of the set of sub-layers 403 for each target layer 400 of the quantum circuit (e.g., quantum circuit 109, such as ID fully entangled GHZ state preparation circuit 300) into a reduced set of “learning layers,” which enables each sub-layer's noise model to be learned from fewer layers (learning layers). That is, noise model learning is performed on this smaller set of learning layers. A “learning layer,” as used herein, refers to a layer (a quantum gate acting on a set of qubits) that is used in combination with other learning layers to form the minimally complete layer set for learning all the layer components used in the quantum circuit (e.g., quantum circuit 300).

In one embodiment, grouping engine 202 combines all the parallelizable components of sub-layers 403 into a minimal set of layers (i.e., learning layers) for learning all the layer components used in the quantum circuit (e.g., ID fully entangled GHZ state preparation circuit 300).

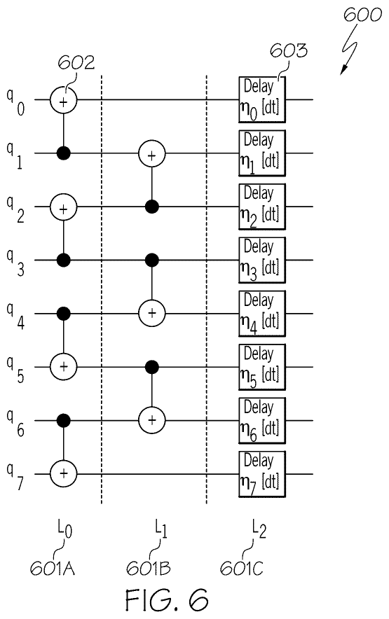

In one embodiment, grouping engine 202 identifies the parallelizable components (independent/weakly dependent layer components) of sub-layers 403 to be combined into a minimal set of learning layers. Parallelization refers to the technique of dividing a large computational task into smaller sub-tasks that can be executed concurrently. Components of sub-layers 403 that are used in such a manner are identified and combined into a reduced set of layers (learning layers) referred to as the “minimally complete layer set.” In one embodiment, grouping engine 202 identifies the parallelizable components of sub-layers 403 by accessing the data attributes of the object of the quantum circuit (e.g., QuantumCircuit object in Qiskit®). Such data attributes include the layer components (e.g., single and two-qubit gates) acting in parallel, which are combined into learning layers as illustrated in FIG. 6.

FIG. 6 illustrates a minimally complete layer set for learning all the layer components used in the target quantum circuit (e.g., 1D fully entangled GHZ state preparation circuit 300) in accordance with an embodiment of the present disclosure.

As shown in FIG. 6, the minimally complete layer set 600 includes the learning layers 601A-601C (identified as L₀, L₁, and L₂, respectively in FIG. 6), which are used for learning all the layer components of the target quantum circuit. Learning layers 601A-601C may collectively or individually be referred to as learning layers 601 or learning layer 601, respectively. Such learning layers 601 include a unitary gate (e.g., CX gates 602 (also referred to as controlled-NOT gates), idle gates 603) acting on a set of qubits. The noise models for each of the set of sub-layers 403 are learned based on the reduced set of learning layers as discussed further below.

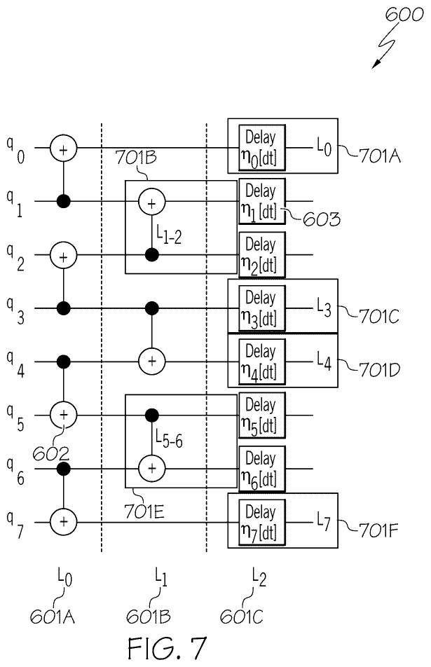

In one embodiment, such learning layers 601 are formed based on layer components, i.e., sub-layers 403, such as shown in FIG. 7.

FIG. 7 illustrates learning layers 601 (FIG. 6) being formed from the grouping of sub-layers 403 (FIG. 4) for each target layer 400 (FIG. 4) in accordance with an embodiment of the present disclosure.

Referring to FIG. 7, in conjunction with FIGS. 4-6, minimally complete layer set 600 includes the layer components of sub-layers 403 of FIG. 4 shown by L₀, L₁₋₂, L₃, Lᵣ, L₅₋₆, L₇, which are identified as 701A-701F, respectively, in FIG. 7.

In one embodiment, gate crosstalk graph 500 of FIG. 5 can be used to ensure that the sub-layers 403 can be combined in the same learning layer (e.g., learning layer 601).

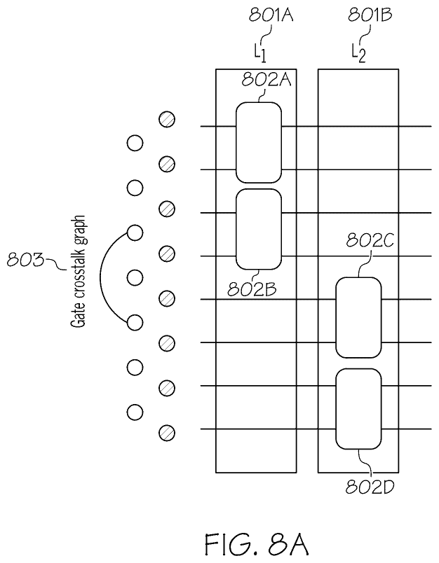

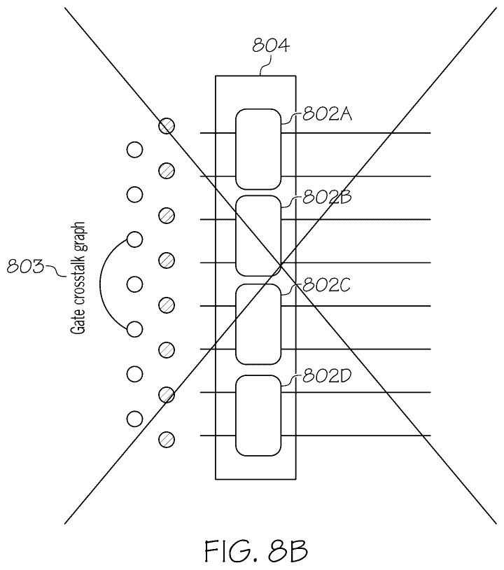

For example, when forming learning layers 601 for learning the sub-layer noise models, the gate crosstalk subgraph (e.g., gate crosstalk subgraph 500) for the learning layer (e.g., learning layer 601) should be the same as for the target layer (e.g., target layer 400). That is, if two sub-layers 403 are in the same learning layer (e.g., learning layer 601), they should either be independent or not applied in isolation in the target layer(s) (e.g., target layer 400) as illustrated in FIGS. 8A-8B.

FIGS. 8A-8B illustrate using the gate crosstalk subgraph when forming the learning layers for learning the sub-layer noise models in accordance with an embodiment of the present disclosure.

As shown in FIG. 8A, target layer 801A (identified as L₁ in FIG. 8A) includes sub-layers 802A-802B. Furthermore, as shown in FIG. 8A, target layer 801B (identified as L₂ in FIG. 8A) includes sub-layers 802C-802D. Target layers 801A-801B may collectively or individually be referred to as target layers 801 or target layer 801, respectively. Target layers 801 are functionally similar to target layer 400 (FIG. 4). Sub-layers 802A-802D may collectively or individually be referred to as sub-layers 802 or sub-layer 802, respectively. Sub-layers 802 are functionally similar to sub-layer 403 (FIG. 4). If crosstalk existed between sub-layer 802B and sub-layer 802C as depicted in gate crosstalk graph 803 (functionally similar to gate crosstalk graph 500 of FIG. 5), then combining them into a single learning layer 804 simply because they do not overlap will provide inaccurate sub-layer noise models for the target layer because the crosstalk environment in the learning layer is different than the target layers as shown in FIG. 8B. Sub-layers 802B and 802C cannot be combined as shown in FIG. 8B because such sub-layers are not independent and are applied in isolation in the target layers (e.g., target layers 801A, 801B).

Returning to FIG. 2, classical computer 102 additionally includes noise model learning engine 203 configured to learn the noise models for each of the sub-layers (e.g., sub-layers 403 of FIG. 4) on the reduced set of learning layers (e.g., learning layers 601 of FIG. 6).

In one embodiment, noise model learning engine 203 learns the noise models for the learning layers (e.g., learning layers 601 of FIG. 6) according to a noise learning protocol in which the learning layers (e.g., learning layers 601 of FIG. 6) contain layers of noisy two-qubit gates interleaved with layers of single-qubit gates. In one embodiment, the noise across each layer of two-qubit gates is modeled as a sparse Pauli-Lindblad error model. In one embodiment, the noise channel is specific to the gates in the learning layer (e.g., learning layer 601) and assumed to be a Pauli channel. In one embodiment, an n-qubit Pauli noise channel is modeled according to a Lindblad master equation. The model parameters are chosen to reflect the noise interactions in the quantum processor and their number, which determines the model complexity and expressivity, typically scales polynomially, and therefore enables one to represent noise models for the full device by a small set of nonnegative coefficients. In one embodiment, the model includes only weight-one and weight-two Pauli terms whose support coincides with the quantum processor's connectivity. The parameters of the resulting model scale linearly with the number of qubits, which ensures that the model is efficiently represented.

Noise model learning engine 203 is further configured to combine the learned noise models forming a complete set of noise models for the target layers (e.g., target layer 400) of the quantum circuit (e.g., 1D fully entangled GHZ state preparation circuit 300). That is, the target layer noise models are “stitched” together from the sub-layer noise model components. In this manner, the noise models for the target layers of the quantum circuits can be learned before the learned noise models are no longer representative of the current device noise environment due to drifting device noise due to the fact that a reduced number of learning layers may be used to learn the noise models of the target quantum circuit. For example, consider the preparation of a one-dimensional N-qubit Greenberger-Horne-Zeilinger (GHZ) state (e.g., 1D fully entangled GHZ state preparation circuit 300), which produces a fully entangled state of N qubits and is an important resource state for quantum computation. Circuit 300 has N/2 unique layers for N qubits. Hence, a 100 qubit GHZ state would require 50 unique learning operations naively. However, using the principles of the present disclosure, the number of learning layers is only three, independent of the number of qubits. As a result of the reduced set of learning layers and using the reduced set of learning layers to learn the noise models for each of the sub-layers of the target layers of the quantum circuit, a complete set of noise models for the target layers of the quantum circuit can be learned before the learned noise models are no longer representative of the current device noise environment due to drifting device noise.

In one embodiment, noise model learning engine 203 utilizes various software tools for combining the learned noise models, such as the Qiskit® Aer noise module.

Furthermore, classical computer 102 includes error mitigation engine 204 configured to perform quantum error mitigation on the quantum circuit (e.g., 1D fully entangled GHZ state preparation circuit 300) using the learned noise models.

In one embodiment, error mitigation engine 204 inverts the learned noise models quasi-probabilistically to perform quantum error mitigation. In one embodiment, such inverted noise models capture the correlated noise and scales to large quantum devices. In one embodiment, the inverse noise model is obtained by negating the model coefficients and gives rise to a quasi-probability distribution on Pauli matrices. Such a distribution is sampled in linear time with the number of model coefficients. The mitigation Paulis can be combined with those used for twirling as well as with the single-qubit operations in the interleaved layers.

In one embodiment, error mitigation engine 204 performs quantum error mitigation on the quantum circuit (e.g., 1D fully entangled GHZ state preparation circuit 300) by using the learned noise models for zero-noise extrapolation, where noiseless expectation values of an observable are extrapolated from a range of expectation values computed at different noise levels identified from the learned noise models.

By performing quantum error mitigation, an estimation of noise-free observable expectation values is obtained.

A further description of these and other functions is provided below in connection with the discussion of the method for learning noise models to perform quantum error mitigation on quantum circuits, such as unstructured quantum circuits (quantum circuits with a large number of unique layers).

Prior to the discussion of the method for learning noise models to perform quantum error mitigation on quantum circuits, a description of the hardware configuration of classical computer 102 (FIG. 1) is provided below in connection with FIG. 9.

Referring now to FIG. 9, in conjunction with FIG. 1, FIG. 9 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code 901 involved in performing the inventive methods, such as learning noise models to perform quantum error mitigation on quantum circuits. In addition to block 901, computing environment 900 includes, for example, classical computer 102, network 113, such as a wide area network (WAN), end user device (EUD) 902, remote server 903, public cloud 904, and private cloud 905. In this embodiment, classical computer 102 includes processor set 906 (including processing circuitry 907 and cache 908), communication fabric 909, volatile memory 910, persistent storage 911 (including operating system 912 and block 901, as identified above), peripheral device set 913 (including user interface (UI) device set 914, storage 915, and Internet of Things (IoT) sensor set 916), and network module 917. Remote server 903 includes remote database 918. Public cloud 904 includes gateway 919, cloud orchestration module 920, host physical machine set 921, virtual machine set 922, and container set 923.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 918. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically classical computer 102, to keep the presentation as simple as possible. Classical computer 102 may be located in a cloud, even though it is not shown in a cloud in FIG. 9. On the other hand, classical computer 102 is not required to be in a cloud except to any extent as may be affirmatively indicated.

Processor set 906 includes one, or more, computer processors of any type now known or to be developed in the future. Processing circuitry 907 may be distributed over multiple packages, for example, multiple, coordinated integrated circuit chips. Processing circuitry 907 may implement multiple processor threads and/or multiple processor cores. Cache 908 is memory that is located in the processor chip package(s) and is typically used for data or code that should be available for rapid access by the threads or cores running on processor set 906. Cache memories are typically organized into multiple levels depending upon relative proximity to the processing circuitry. Alternatively, some, or all, of the cache for the processor set may be located “off chip.” In some computing environments, processor set 906 may be designed for working with qubits and performing quantum computing.

Computer readable program instructions are typically loaded onto classical computer 102 to cause a series of operational steps to be performed by processor set 906 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 908 and the other storage media discussed below. The program instructions, and associated data, are accessed by processor set 906 to control and direct performance of the inventive methods. In computing environment 900, at least some of the instructions for performing the inventive methods may be stored in block 901 in persistent storage 911.

Communication fabric 909 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 910 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 910 is located in a single package and is internal to classical computer 102, but, alternatively or additionally, the volatile memory may be distributed over multiple packages and/or located externally with respect to classical computer 102.

Persistent Storage 911 is any form of non-volatile storage for computers that is now known or to be developed in the future. The non-volatility of this storage means that the stored data is maintained regardless of whether power is being supplied to classical computer 102 and/or directly to persistent storage 911. Persistent storage 911 may be a read only memory (ROM), but typically at least a portion of the persistent storage allows writing of data, deletion of data and re-writing of data. Some familiar forms of persistent storage include magnetic disks and solid state storage devices. Operating system 912 may take several forms, such as various known proprietary operating systems or open source Portable Operating System Interface type operating systems that employ a kernel. The code included in block 901 typically includes at least some of the computer code involved in performing the inventive methods.

Peripheral device set 913 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 914 may include components such as a display screen, speaker, microphone, wearable devices (such as goggles and smart watches), keyboard, mouse, printer, touchpad, game controllers, and haptic devices. Storage 915 is external storage, such as an external hard drive, or insertable storage, such as an SD card. Storage 915 may be persistent and/or volatile. In some embodiments, storage 915 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 916 is made up of sensors that can be used in Internet of Things applications. For example, one sensor may be a thermometer and another sensor may be a motion detector.

Network module 917 is the collection of computer software, hardware, and firmware that allows classical computer 102 to communicate with other computers through WAN 113. Network module 917 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 917 are performed on the same physical hardware device. In other embodiments (for example, embodiments that utilize software-defined networking (SDN)), the control functions and the forwarding functions of network module 917 are performed on physically separate devices, such that the control functions manage several different network hardware devices. Computer readable program instructions for performing the inventive methods can typically be downloaded to classical computer 102 from an external computer or external storage device through a network adapter card or network interface included in network module 917.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 902 is any computer system that is used and controlled by an end user (for example, a customer of an enterprise that operates classical computer 102), and may take any of the forms discussed above in connection with classical computer 102. EUD 902 typically receives helpful and useful data from the operations of classical computer 102. For example, in a hypothetical case where classical computer 102 is designed to provide a recommendation to an end user, this recommendation would typically be communicated from network module 917 of classical computer 102 through WAN 113 to EUD 902. In this way, EUD 902 can display, or otherwise present, the recommendation to an end user. In some embodiments, EUD 902 may be a client device, such as thin client, heavy client, mainframe computer, desktop computer and so on.

Remote server 903 is any computer system that serves at least some data and/or functionality to classical computer 102. Remote server 903 may be controlled and used by the same entity that operates classical computer 102. Remote server 903 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 918 of remote server 903.

Public cloud 904 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 904 is performed by the computer hardware and/or software of cloud orchestration module 920. The computing resources provided by public cloud 904 are typically implemented by virtual computing environments that run on various computers making up the computers of host physical machine set 921, which is the universe of physical computers in and/or available to public cloud 904. The virtual computing environments (VCEs) typically take the form of virtual machines from virtual machine set 922 and/or containers from container set 923. It is understood that these VCEs may be stored as images and may be transferred among and between the various physical machine hosts, either as images or after instantiation of the VCE. Cloud orchestration module 920 manages the transfer and storage of images, deploys new instantiations of VCEs and manages active instantiations of VCE deployments. Gateway 919 is the collection of computer software, hardware, and firmware that allows public cloud 904 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 905 is similar to public cloud 904, except that the computing resources are only available for use by a single enterprise. While private cloud 905 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 904 and private cloud 905 are both part of a larger hybrid cloud.

Block 901 further includes the software components discussed above in connection with FIGS. 2-7 and 8A-8B to learn noise models to perform quantum error mitigation on quantum circuits. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for learning noise models to perform quantum error mitigation on quantum circuits, may be embodied in an application specific integrated circuit.

As stated above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty measurement outcomes. Techniques, such as quantum error mitigation techniques, have been developed to reduce (mitigate) the errors that occur in quantum computing algorithms. Recently, quantum error mitigation techniques have been performed using learned noise models (e.g., sparse Pauli noise models) to perform accurate calculations with noisy quantum hardware. A noise model refers to a computer model used to predict the noise acting on the quantum state of a noisy quantum computer. For example, a sparse Pauli noise model is a model for the noise acting on the quantum state of a noisy quantum computer under the action of a Clifford layer with Pauli twirling. Such noise models, such as the sparse Pauli noise model, are learned according to a noise learning protocol, where each unique layer of gates in the quantum circuit has an associated noise model. The noise model for each layer of the quantum circuit may then be inverted quasi-probabilistically according to the noise learning protocol or used for zero-noise extrapolation to perform quantum error mitigation thereby allowing the estimation of noise-free observable expectation values. Unfortunately, quantum error mitigation using learned noise models is limited to quantum circuits with a small set of unique quantum gate layers. Quantum circuits though may contain many unique layers which makes it difficult to learn each unique layer noise model. For example, because the noise properties of noisy quantum computers drift on a timescale of about a day or less, learning the noise models needs to be performed as quickly as possible to ensure that the learned noise model reflects current device conditions. However, because of the long time to learn the noise models, the noise models for each layer of a quantum circuit that contains many unique layers may not be learned quick enough to address the device's noise drift. Drift is any nontrivial time dependence in the outcome probabilities of a quantum circuit. As a result, the drifted noise (drifting of the noise properties of noisy quantum computers) creates a mismatch between the actual noise characteristics on the quantum hardware and the noise model. Consequently, due to drifting device noise, the current approach of learning each unique layer noise model for a quantum circuit is limited in the number of unique layers than can be learned before the learned noise models are no longer representative of the current device noise environment.

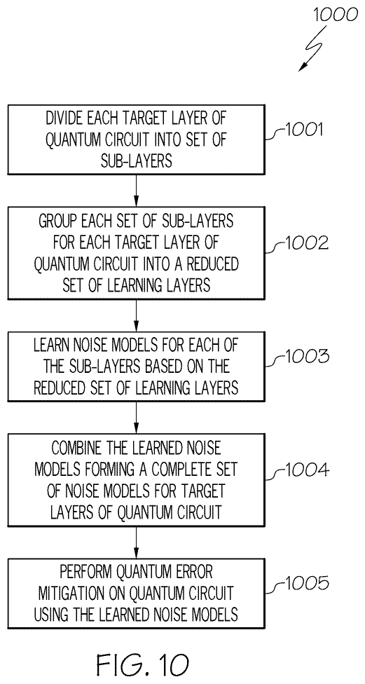

The embodiments of the present disclosure provide the means for learning many unique layer noise models for a quantum circuit before the learned noise models are no longer representative of the current device noise environment by leveraging low device crosstalk as discussed below in connection with FIG. 10.

FIG. 10 is a flowchart of a method 1000 for learning noise models to perform quantum error mitigation on quantum circuits, such as on unstructured quantum circuits (quantum circuit with a large number of unique layers), in accordance with an embodiment of the present disclosure.

Referring to FIG. 10, in conjunction with FIGS. 1-7, 8A-8B and 9, in step 1001, divider engine 201 of classical computer 102 divides each target layer (e.g., target layer 400) of a quantum circuit (e.g., ID fully entangled GHZ state preparation circuit 300) into a set of sub-layers.

As discussed above, the “target layer” of the quantum circuit, as used herein, refers to a layer of the quantum circuit upon which quantum error mitigation is to be performed. A “layer,” as used herein, refers to a quantum gate (unitary matrix U_{L}) acting on a set of qubits, usually a combination of single and two-qubit gates acting in parallel. That is, the layer includes the component operations that are applied simultaneously to the quantum device (e.g., quantum circuit). A “sub-layer,” as used herein, refers to a quantum gate(s) or component operation(s) acting on a subset of a larger layer (e.g., target layer).

In one embodiment, divider engine 201 identifies the quantum gate(s) or component operation(s) acting on a subset of a larger layer (e.g., target layer) by using the QuantumCircuit.data function of Qiskit®. Based on such an identification, such quantum gate(s) or component operation(s) form the sub-layer(s) of the targe layer.

An example of a quantum circuit (e.g., quantum circuit) with multiple target layers is provided in FIG. 3.

As shown in FIG. 3, the number of unique layers (target layers)=N/2 for N qubits. For example, circuit 300 includes 8 qubits (qₒ to q₇). As a result, ID fully entangled GHZ state preparation circuit 300 has 4 unique layers (target layers) 301A-301D.

Furthermore, as discussed above, a layer refers to a quantum gate (unitary matrix U_{L}) acting on a set of qubits, usually a combination of single and two-qubit gates acting in parallel. In one embodiment, each gate layer has a unique model associated with it. A “sub-layer” refers to a quantum gate acting on a subset of a larger layer as illustrated in FIG. 4. Noise models for the sub-layers can be learned separately.

As shown in FIG. 4, target layer 400 (e.g., layer 301A of circuit 300) consists of various component operations that are applied simultaneously to the device (e.g., quantum circuit), such as two parallel CX gates 401 and idle gates 402. In one embodiment, divider engine 201 divides target layer 400 into a set of sub-layers 403A-403F (identified as L₀, L₁₋₂, L₃, Lᵣ, L₅₋₆, L₇, respectively, in FIG. 4) consisting of the target layer component operations (e.g., CX gates 401, idle gates 402). As discussed above, sub-layers 403 include the component operations of the target layer, such as target layer 400.

Since the model coefficients on one edge or qubit do not affect the coefficients on another edge/qubit, there is no/low crosstalk. Hence, L_{c}=⊗Lᵢ, where Lᵢ corresponds to sub-layers 403 defined on the components (qubits, edges) of the target layer L_{c}. It is noted that ⊗ corresponds to the tensor product as Lᵢ is a unitary operation on sub-graph i.

In one embodiment, in the ideal case of zero crosstalk, each sub-layer 403 could simply be each single and two-qubit gate in target layer 400. Crosstalk, as used herein, refers to when one gate application affects the performance of a separate gate application (e.g., a CNOT gate on one pair of qubits adds an error to a CNOT gate on another pair of qubits).

In one embodiment, divider engine 201 divides each target layer 400 of the quantum circuit (e.g., quantum circuit 109) into a set of sub-layers 403 taking into consideration cross-talk. For example, if one gate's noise model is known to depend on whether another gate is also present in target layer 400, then those two gates can be grouped to form a sub-layer 403. In one embodiment, divider engine 201 obtains such cross-talk information using a gate crosstalk graph of the device (e.g., quantum circuit) as illustrated in FIG. 5.

As shown in FIG. 5, gate crosstalk graph 500 illustrates crosstalk between gates by using nodes 501, 502 corresponding to single-qubit gates (S) (e.g., idle gates, do nothing gates) and two-qubit gates (T), respectively. Furthermore, edges 503A-503C indicate crosstalk between gates 501, 502.

As further shown in FIG. 5, gate crosstalk graph 500 illustrates three types of crosstalk types. For example, gate crosstalk graph 500 illustrates crosstalk between single-qubit gates (S) 501, resulting in the crosstalk type of S-S, which is labeled as “1” 504 in FIG. 5. In another example, gate crosstalk graph 500 illustrates crosstalk between two-qubit gates (T) 502, resulting in the crosstalk type of T-T, which is labeled as “2” 505 in FIG. 5. In a further example, gate crosstalk graph 500 illustrates crosstalk between a single-qubit gate (S) and a two-qubit gate (T) or vice-versa, resulting in the crosstalk type of S-T or T-S, which is labeled as “3” 506 in FIG. 5.

In one embodiment, with information about gate crosstalk graph 500 of the quantum device (e.g., quantum circuit), sub-layers 403 of a target layer 400 will be the set of connected subgraphs of target layer 400 on gate crosstalk graph 500.

For example, in the scenario in which a CNOT gate on one pair of qubits adds an error to a CNOT gate on another pair of qubits, divider engine 201 divides target layer 400 in such a manner that a sub-layer 403 would contain both CNOT gates.

In one embodiment, divider engine 201 obtains gate crosstalk graph 500 by detecting the existence of crosstalk based on detecting changes in the observe outcome frequencies for the quantum circuit (e.g., quantum circuit 109). In one embodiment, quantum circuit 109 is run on “spectator” qubit(s) while leaving alone the “driver” qubit(s). The process is then repeated while gates are run on the driver qubit(s). Based on the consistency of the two datasets, crosstalk can be detected.

In another embodiment, divider engine 201 obtains gate crosstalk graph 500 by quantifying crosstalk through idle tomography involving identifying the idle decay rate differences (equal to the sum of stochastic Y and Z errors induced by crosstalk) on the spectator qubit(s), where the type and rate of crosstalk errors can be inferred.

In one embodiment, divider engine 201 obtains gate crosstalk graph 500 by detecting crosstalk via conditional independence testing.

In step 1002, grouping engine 202 of classical computer 102 groups each of the set of sub-layers 403 for each target layer 400 of the quantum circuit (e.g., quantum circuit 109, such as 1D fully entangled GHZ state preparation circuit 300) into a reduced set of “learning layers,” which enables each sub-layer's noise model to be learned from fewer layers (learning layers). That is, noise model learning is performed on this smaller set of learning layers. A “learning layer,” as used herein, refers to a layer (a quantum gate acting on a set of qubits) that is used in combination with other learning layers to form the minimally complete layer set for learning all the layer components used in the quantum circuit (e.g., 1D fully entangled GHZ state preparation circuit 300).

As stated above, in one embodiment, grouping engine 202 combines all the parallelizable components of sub-layers 403 into a minimal set of layers (i.e., learning layers) for learning all the layer components used in the quantum circuit (e.g., 1D fully entangled GHZ state preparation circuit 300).

In one embodiment, grouping engine 202 identifies the parallelizable components (independent/weakly dependent layer components) of sub-layers 403 to be combined into a minimal set of learning layers. Parallelization refers to the technique of dividing a large computational task into smaller sub-tasks that can be executed concurrently. Components of sub-layers 403 that are used in such a manner are identified and combined into a reduced set of layers (learning layers) referred to as the “minimally complete layer set.” In one embodiment, grouping engine 202 identifies the parallelizable components of sub-layers 403 by accessing the data attributes of the object of the quantum circuit (e.g., QuantumCircuit object in Qiskit®). Such data attributes include the layer components (e.g., single and two-qubit gates) acting in parallel, which are combined into learning layers as illustrated in FIG. 6.

As shown in FIG. 6, the minimally complete layer set 600 includes the learning layers 601A-601C (identified as L₀, L₁, and L₂, respectively in FIG. 6), which are used for learning all the layer components of the target quantum circuit. Such learning layers 601 include a unitary gate (e.g., CX gates 602 (also referred to as controlled-NOT gates), idle gates 603) acting on a set of qubits. The noise models for each of the set of sub-layers 403 are learned based on the reduced set of learning layers.

In one embodiment, such learning layers 601 are formed based on layer components, i.e., sub-layers 403, such as shown in FIG. 7.

Referring to FIG. 7, minimally complete layer set 600 includes the layer components of sub-layers 403 of FIG. 4 shown by L₀, L₁₋₂, L₃, Lᵣ, L₅₋₆, L₇, which are identified as 701A-701F, respectively, in FIG. 7.

In one embodiment, gate crosstalk graph 500 of FIG. 5 can be used to ensure that the sub-layers 403 can be combined in the same learning layer (e.g., learning layer 601).

For example, when forming learning layers 601 for learning the sub-layer noise models, the gate crosstalk subgraph (e.g., gate crosstalk subgraph 500) for the learning layer (e.g., learning layer 601) should be the same as for the target layer (e.g., target layer 400). That is, if two sub-layers 403 are in the same learning layer (e.g., learning layer 601), they should either be independent or not applied in isolation in the target layer(s) (e.g., target layer 400) as illustrated in FIGS. 8A-8B.

As shown in FIG. 8A, target layer 801A (identified as L₁ in FIG. 8A) includes sub-layers 802A-802B. Furthermore, as shown in FIG. 8A, target layer 801B (identified as L₂ in FIG. 8A) includes sub-layers 802C-802D. Target layers 801 are functionally similar to target layer 400 (FIG. 4). Furthermore, sub-layers 802 are functionally similar to sub-layer 403 (FIG. 4). If crosstalk existed between sub-layer 802B and sub-layer 802C as depicted in gate crosstalk graph 803 (functionally similar to gate crosstalk graph 500 of FIG. 5), then combining them into a single learning layer 804 simply because they do not overlap will provide inaccurate sub-layer noise models for the target layer because the crosstalk environment in the learning layer is different than the target layers as shown in FIG. 8B. Sub-layers 802B and 802C cannot be combined as shown in FIG. 8B because such sub-layers are not independent and are applied in isolation in the target layers (e.g., target layers 801A, 801B).

In step 1003, noise model learning engine 203 of classical computer 102 learns the noise models for each of the sub-layers (e.g., sub-layers 403 of FIG. 4) on the reduced set of learning layers (e.g., learning layers 601 of FIG. 6).

As discussed above, in one embodiment, noise model learning engine 203 learns the noise models for the learning layers (e.g., learning layers 601 of FIG. 6) according to a noise learning protocol in which the learning layers (e.g., learning layers 601 of FIG. 6) contain layers of noisy two-qubit gates interleaved with layers of single-qubit gates. In one embodiment, the noise across each layer of two-qubit gates is modeled as a sparse Pauli-Lindblad error model. In one embodiment, the noise channel is specific to the gates in the learning layer (e.g., learning layer 601) and assumed to be a Pauli channel. In one embodiment, an n-qubit Pauli noise channel is modeled according to a Lindblad master equation. The model parameters are chosen to reflect the noise interactions in the quantum processor and their number, which determines the model complexity and expressivity, typically scales polynomially, and therefore enables one to represent noise models for the full device by a small set of nonnegative coefficients. In one embodiment, the model includes only weight-one and weight-two Pauli terms whose support coincides with the quantum processor's connectivity. The parameters of the resulting model scale linearly with the number of qubits, which ensures that the model is efficiently represented.

In step 1004, noise model learning engine 203 of classical computer 102 combines the learned noise models forming a complete set of noise models for the target layers (e.g., target layer 400) of the quantum circuit (e.g., 1D fully entangled GHZ state preparation circuit 300). That is, the target layer noise models are “stitched” together from the sub-layer noise model components. In this manner, the noise models for the target layers of the quantum circuits can be learned before the learned noise models are no longer representative of the current device noise environment due to drifting device noise due to the fact that a reduced number of learning layers may be used to learn the noise models of the target quantum circuit. For example, consider the preparation of a one-dimensional N-qubit Greenberger-Horne-Zeilinger (GHZ) state (e.g., 1D fully entangled GHZ state preparation circuit 300), which produces a fully entangled state of N qubits and is an important resource state for quantum computation. Circuit 300 has N/2 unique layers for N qubits. Hence, a 100 qubit GHZ state would require 50 unique learning operations naively. However, using the principles of the present disclosure, the number of learning layers is only three, independent of the number of qubits. As a result of the reduced set of learning layers and using the reduced set of learning layers to learn the noise models for each of the sub-layers of the target layers of the quantum circuit, a complete set of noise models for the target layers of the quantum circuit can be learned before the learned noise models are no longer representative of the current device noise environment due to drifting device noise.

As stated above, in one embodiment, noise model learning engine 203 utilizes various software tools for combining the learned noise models, such as the Qiskit® Aer noise module.

In step 1005, error mitigation engine 204 of classical computer 102 performs quantum error mitigation on the quantum circuit (e.g., 1D fully entangled GHZ state preparation circuit 300) using the learned noise models.

As stated above, in one embodiment, error mitigation engine 204 inverts the learned noise models quasi-probabilistically to perform quantum error mitigation. In one embodiment, such inverted noise models capture the correlated noise and scales to large quantum devices. In one embodiment, the inverse noise model is obtained by negating the model coefficients and gives rise to a quasi-probability distribution on Pauli matrices. Such a distribution is sampled in linear time with the number of model coefficients. The mitigation Paulis can be combined with those used for twirling as well as with the single-qubit operations in the interleaved layers.

In one embodiment, error mitigation engine 204 performs quantum error mitigation on the quantum circuit (e.g., 1D fully entangled GHZ state preparation circuit 300) by using the learned noise models for zero-noise extrapolation, where noiseless expectation values of an observable are extrapolated from a range of expectation values computed at different noise levels identified from the learned noise models.

By performing quantum error mitigation, an estimation of noise-free observable expectation values is obtained.

As a result of the foregoing, a complete set of noise models for the target layers of the quantum circuit can be learned before the learned noise models are no longer representative of the current device noise environment due to drifting device noise.

Furthermore, the principles of the present disclosure improve the technology or technical field involving quantum error mitigation.

As discussed above, quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty measurement outcomes. Techniques, such as quantum error mitigation techniques, have been developed to reduce (mitigate) the errors that occur in quantum computing algorithms. Recently, quantum error mitigation techniques have been performed using learned noise models (e.g., sparse Pauli noise models) to perform accurate calculations with noisy quantum hardware. A noise model refers to a computer model used to predict the noise acting on the quantum state of a noisy quantum computer. For example, a sparse Pauli noise model is a model for the noise acting on the quantum state of a noisy quantum computer under the action of a Clifford layer with Pauli twirling. Such noise models, such as the sparse Pauli noise model, are learned according to a noise learning protocol, where each unique layer of gates in the quantum circuit has an associated noise model. The noise model for each layer of the quantum circuit may then be inverted quasi-probabilistically according to the noise learning protocol or used for zero-noise extrapolation to perform quantum error mitigation thereby allowing the estimation of noise-free observable expectation values. Unfortunately, quantum error mitigation using learned noise models is limited to quantum circuits with a small set of unique quantum gate layers. Quantum circuits though may contain many unique layers which makes it difficult to learn each unique layer noise model. For example, because the noise properties of noisy quantum computers drift on a timescale of about a day or less, learning the noise models needs to be performed as quickly as possible to ensure that the learned noise model reflects current device conditions. However, because of the long time to learn the noise models, the noise models for each layer of a quantum circuit that contains many unique layers may not be learned quick enough to address the device's noise drift. Drift is any nontrivial time dependence in the outcome probabilities of a quantum circuit. As a result, the drifted noise (drifting of the noise properties of noisy quantum computers) creates a mismatch between the actual noise characteristics on the quantum hardware and the noise model. Consequently, due to drifting device noise, the current approach of learning each unique layer noise model for a quantum circuit is limited in the number of unique layers than can be learned before the learned noise models are no longer representative of the current device noise environment.

Embodiments of the present disclosure improve such technology by dividing each target layer of a quantum circuit into a set of sub-layers. The “target layer” of the quantum circuit, as used herein, refers to a layer of the quantum circuit upon which quantum error mitigation is to be performed. A “layer,” as used herein, refers to a quantum gate (unitary matrix U_{L}) acting on a set of qubits, usually a combination of single and two-qubit gates acting in parallel. That is, the layer includes the component operations that are applied simultaneously to the quantum device (e.g., quantum circuit). A “sub-layer,” as used herein, refers to a quantum gate(s) or component operation(s) acting on a subset of a larger layer (e.g., target layer). Furthermore, each of the sub-layers for each target layer of the quantum circuit is grouped into a reduced set of“learning layers,” which enables each sub-layer's noise model to be learned from fewer layers (learning layers). A “learning layer,” as used herein, refers to a layer (a quantum gate acting on a set of qubits) that is used in combination with other learning layers to form the minimally complete layer set for learning all the layer components used in the quantum circuit. In one embodiment, such grouping combines all the parallelizable components of the sub-layers into a minimal set of layers (i.e., learning layers) for learning all the layer components used in the quantum circuit. The noise models for each of the sub-layers are then learned on the reduced set of learning layers. In one embodiment, the noise models for the learning layers are learned according to a noise learning protocol in which the learning layers contain layers of noisy two-qubit gates interleaved with layers of single-qubit gates. Such learned noise models are combined to form a complete set of noise models for the target layers of the quantum circuit and used to perform quantum error mitigation on the quantum circuit. In this manner, a complete set of noise models for the target layers of the quantum circuit can be learned before the learned noise models are no longer representative of the current device noise environment due to drifting device noise. Furthermore, in this manner, there is an improvement in the technical field involving quantum error mitigation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for learning noise models to perform quantum error mitigation, the method comprising:
dividing each target layer of a quantum circuit into a set of sub-layers;
grouping each of said set of sub-layers for each target layer of said quantum circuit into a reduced set of learning layers; and
learning said noise models for each of said set of sub-layers based on said reduced set of learning layers.

2. The method as recited in claim 1, wherein each sub-layer in said set of sub-layers comprises each single and two-qubit gate in a target layer of said quantum circuit.

3. The method as recited in claim 1 further comprising:
grouping each of said set of sub-layers for each target layer of said quantum circuit using a gate crosstalk graph.

4. The method as recited in claim 1, wherein said grouping of each of said set of sub-layers for each target layer of said quantum circuit into said reduced set of learning layers comprises combining all parallelizable components in each of said set of sub-layers for each target layer of said quantum circuit.

5. The method as recited in claim 1 further comprising:
combining said learned noise models forming a complete set of noise models for target layers of said quantum circuit.

6. The method as recited in claim 1 further comprising:
performing quantum error mitigation on said quantum circuit using said learned noise models.

7. The method as recited in claim 1, wherein said quantum circuit is unstructured.

8. A computer program product for learning noise models to perform quantum error mitigation, the computer program product comprising one or more computer readable storage mediums having program code embodied therewith, the program code comprising programming instructions for:
dividing each target layer of a quantum circuit into a set of sub-layers;
grouping each of said set of sub-layers for each target layer of said quantum circuit into a reduced set of learning layers; and
learning said noise models for each of said set of sub-layers based on said reduced set of learning layers.

9. The computer program product as recited in claim 8, wherein each sub-layer in said set of sub-layers comprises each single and two-qubit gate in a target layer of said quantum circuit.

10. The computer program product as recited in claim 8, wherein the program code further comprises the programming instructions for:
grouping each of said set of sub-layers for each target layer of said quantum circuit using a gate crosstalk graph.

11. The computer program product as recited in claim 8, wherein said grouping of each of said set of sub-layers for each target layer of said quantum circuit into said reduced set of learning layers comprises combining all parallelizable components in each of said set of sub-layers for each target layer of said quantum circuit.

12. The computer program product as recited in claim 8, wherein the program code further comprises the programming instructions for:
combining said learned noise models forming a complete set of noise models for target layers of said quantum circuit.

13. The computer program product as recited in claim 8, wherein the program code further comprises the programming instructions for:
performing quantum error mitigation on said quantum circuit using said learned noise models.

14. The computer program product as recited in claim 8, wherein said quantum circuit is unstructured.

15. A system, comprising:
a memory for storing a computer program for learning noise models to perform quantum error mitigation; and
a processor connected to said memory, wherein said processor is configured to execute program instructions of the computer program comprising:
dividing each target layer of a quantum circuit into a set of sub-layers;
grouping each of said set of sub-layers for each target layer of said quantum circuit into a reduced set of learning layers; and
learning said noise models for each of said set of sub-layers based on said reduced set of learning layers.

16. The system as recited in claim 15, wherein each sub-layer in said set of sub-layers comprises each single and two-qubit gate in a target layer of said quantum circuit.

17. The system as recited in claim 15, wherein the program instructions of the computer program further comprise:
grouping each of said set of sub-layers for each target layer of said quantum circuit using a gate crosstalk graph.

18. The system as recited in claim 15, wherein said grouping of each of said set of sub-layers for each target layer of said quantum circuit into said reduced set of learning layers comprises combining all parallelizable components in each of said set of sub-layers for each target layer of said quantum circuit.

19. The system as recited in claim 15, wherein the program instructions of the computer program further comprise:
combining said learned noise models forming a complete set of noise models for target layers of said quantum circuit.

20. The system as recited in claim 15, wherein the program instructions of the computer program further comprise:
performing quantum error mitigation on said quantum circuit using said learned noise models.
